(19) United States
(12) Patent Application Publication
(10) Pub. No.: US 2007/0271535 A1
(43) Pub. Date: Nov. 22, 2007

(54) Method for crosstalk elimination and bus architecture performing the same

(75) Inventors: Ting Ting Hwang, Hsinchu (TW); Wen Wen Hsieh, Sinjhuang City (TW)

Correspondence Address: John S. Egbert;Egbert Law Offices, 7th Floor, 412 Main Street, Houston, TX, 77002, US

(73) Assignee: NATIONAL TSING HUA UNIVERSITY, Hsinchu (TW)

(21) Appl. No.: 11/434,961

(22) Filed: May 16, 2006

(51) Int. Cl. G06F 17/50

(52) U.S. Cl. 716/5

(57) ABSTRACT

The present invention discloses a method for crosstalk elimination in high-performance processors. The method, based on the combination of a deassembler and an assembler, eliminates crosstalk with fewer extra wires. The method of the present invention includes the steps of: deassembling a first piece of data to a plurality of data segments; conducting a parallel crosstalk check on the data segments to form a second piece of data that is crosstalk-free; and restoring the first piece of data based on the second piece of data. The present invention also discloses a bus architecture performing the method for crosstalk elimination, which includes a deassembler, a transmission bus and an assembler.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The present invention relates to a method for crosstalk elimination, and more particularly to a method for crosstalk elimination based on the combination of a deassembler and an assembler, which is especially suitable for crosstalk elimination in high-performance processor design.

### BACKGROUND OF THE INVENTION

Crosstalk is the effect in which the signal on a wire is affected by signals switching on its neighboring wires due to the coupling capacitances. This effect leads to an increase in delay, power consumption, and in the worst case, to an incorrect result. With technology scaling down to deep sub-micron, the crosstalk effect between adjacent wires becomes an important issue, especially between long on-chip buses. Thus, elimination of crosstalk has become a very important design issue. Since, in a bus structure, a number of wires are laid in parallel for a long distance, the crosstalk problem in a bus structure is especially salient.

Two major categories of crosstalk elimination approaches have been proposed. The first category is designed for power consumption and its objective is to minimize the total crosstalk in all wires (referring to “A Novel VLSI Layout Fabric for Deep Sub-Micro Application” by S. P. Khatri, et al., published in Design Automation Conference, pp. 491-496, June 1999, “Optimal Shielding/Spacing Metrics for Low Power Design” by R. Arunachalam, et al., published in IEEE Computer Society Annual Symposium on VLSI, pp. 167-172, February 2003 and “Re-configurable Bus Encoding Scheme for Reducing Power Consumption of the Cross Coupling Capacitance for Deep Sub-Micron Instruction Bus” by S. K. Wong, et al., published in Design, Automation, and Test in Europe Conference and Exhibition, vol. 1, pp. 130-135, November 2004). The second category is designed for performance and its objective is to minimize the maximum crosstalk effect among all wires (referring to “Bus encoding to prevent crosstalk delay” by B. Victor, et al., published in IEEE/ACM International Conference on Computer Aided Design, pp. 57-63, November 2001, “Analysis and Avoidance of Cross-talk in On-Chip Buses” by C. Duan, et al., published in Hot Interconnects, pp. 133-138, August 2001 and “Exploiting Crosstalk to Speed up On-Chip Buses” by C. Duan, et al., published in Design, Automation and Test in Europe Conference and Exhibition, pp. 778-783, February 2004).

The methods in the second category use bus-encoding methods to minimize the maximum crosstalk. All of them proposed that encoding data be crosstalk-free before it is transmitted on the bus. At the receiving end of the bus, a decoder logic decodes the data into the original one. The goal of the methods is to forbid the signals of adjacent wires to switch directions at the same time. The basic idea is shown in FIG. 1, which is a traditional bus encoding scheme. A Sender 10 sends a b-bit data called a symbol. Then the symbol is encoded to a (b+n) bit codeword by an Encoder 11 (b and n are positive integers) and transmitted on a channel 14, which comprises (b+n) wires. At the receiving end, the codeword is decoded by a Decoder 12 to the original b-bit data before being sent to a Receiver 13. The objective of this encoding scheme is to prevent certain defined crosstalk sequences. Hence, the encoded codeword is a crosstalk-free sequence. The information of the mappings between the symbols and the codewords is stored in a codebook.

In Victor's paper, two kinds of encoding methods, with memory and without memory, are proposed. The encoding method with memory stores the previous codewords' state in both the Encoder 11 and the Decoder 12, and changes the content of the codebook after every transmission. On the other hand, the encoding method without memory has a fixed codebook and does not require storing the previous codewords' information. The experiment results from Victor's paper show that it takes 40-bit wires and 46-bit wires to encode a 32-bit bus by using the encoding method with memory and without memory, respectively. However, the encoding method with memory has more hardware overhead costs in the Encoder 11 than that without memory. In Duan's paper in 2001, the symbol is first divided into several groups, and then each group is encoded to be crosstalk-free through a corresponding encoder. Although there is no crosstalk within each individual group, the crosstalk may occur across the group boundaries. In such a case, inverting one of the encoding outputs until group boundaries are crosstalk-free is proposed. The extra wires for inverting information of each group also need to be encoded to be crosstalk-free in the same way. According to the experiment results shown in Duan's paper in 2001, a 32-bit bus is encoded to 52-bit wires. Victor et al. also prove theoretically that the maximum number of wires for encoding an n-bit bus is [logFₙ₊₂], where Fₙ is the nₜₕ number of the Fibonacci sequence. The aforesaid encoding methods become impractical when the number of the bus becomes large. For example, a 128-bit bus will be encoded with 171 wires in theory and with 213 wires in practice. For high-performance processors like superscalar and VLIW (Very Large Instruction Word) architecture, the width of a bus is usually large. Therefore, the aforesaid methods are not appropriate.

A common crosstalk model is introduced below to explain the crosstalk effect. There are two kinds of capacitance with which a single wire is associated. One is the capacitance C_{ground} between the wire and ground, and the other is the coupling capacitance C_{couple} between the wire and its neighboring wires. The total capacitance Cₜₒₜₐₗ of a signal wire is calculated by formula (1).

Cₜₒₜₐₗ=C_{ground}+n×C_{couple}, 0≦n≦4, (1)

where n depends on the types of coupling of its neighboring wires. A more detailed analysis of Cₜₒₜₐₗ on delay can be found in “Reducing Bus Delay in Submicron Technology Using Coding” by P. P. Sotiradis and A. Chandrakasan, published in IEEE Asia and South Pacific Design Automation Conference, pp. 109-114, January-February 2001. The coupling capacitance of a wire can be classified into four types, 1C, 2C, 3C and 4C, according to the C_{couple} of two wires (refer to Duan's paper in 2001). Let the crosstalk effect on a single wire (victim) depend on the signal transition of its neighboring wires (aggressors). A tri-tuple (wᵢ₋₁,wᵢ,wᵢ₊₁) is used to represent the wire signal pattern at a certain time, where wᵢ represents the victim while wᵢ₋₁ and wᵢ₊₁ are aggressors.

TABLE 1

| crosstalk | | |
|---|---|---|
| type | time | bit pattern (wᵢ₋ₗ, wᵢ, wᵢ₊ₗ) |
| 1C | Tₜ₋ₗ | (b, b, b) (b, b, b) (b, b̅, b̅) ( b̅, b̅, b) |
| | Tₜ | (b, b̅, b̅) ( b̅, b̅, b) (b, b, b) (b, b, b) |
| 2C | Tₜ₋ₗ | (b, b, b) ( b̅, b, b) (b, b, b̅) ( b̅, b, b̅) (b, b, b̅) ( b̅, b, b) |
| | Tₜ | (b, b̅, b) ( b̅, b̅, b) (b, b̅, b̅) ( b̅, b̅, b̅) ( b̅, b̅, b) (b, b̅, b̅) |
| 3C | Tₜ₋ₗ | (b, b̅, b) (b, b̅, b) ( b̅, b̅, b) (b, b̅, b̅) |
| | Tₜ | (b, b, b̅) ( b̅, b, b) ( b̅, b, b̅) ( b̅, b, b̅) |
| 4C | Tₜ₋ₗ | (b, b̅, b) |
| | Tₜ | ( b̅, b, b̅) |

Table 1 shows the relations between crosstalk and the wire signal transition at time Tₜ₋₁ and time Tₜ, where (b, b̅)ε{0,1} and b̅ is the complement of b. FIGS. 2(a) and 2(b) show the 4C crosstalk examples on three wires wᵢ₋₁, wᵢ and wᵢ₊₁. The signal patterns transmitted on the wires are (1,0,1) at time Tₜ₋₁ and (0,1,0) at time Tₜ in FIG. 2(a), and (0,1,0) at time Tₜ₋₁ and (1,0,1) at time Tₜ in FIG. 2(b). Note that the transmission of a pattern (b,b,b) followed by any other patterns would never cause signals on adjacent wires to switch in different directions, since the signals in pattern (b,b,b) are the same. Taking the pattern (0,0,0) as an example, the signal on each wire is either switching from 1 to 0 or stays the same 0, and hence the case where adjacent wires switch from 0 to 1 would never happen. Therefore, the transmission pattern with all 0's (or all 1's) followed by any other pattern will never incur 3C/4C crosstalk.

### BRIEF SUMMARY OF THE INVENTION

The objective of the present invention is to provide a method for crosstalk elimination, by conducting a parallel crosstalk check and shifting the data segments to the next channel, to eliminate the crosstalk of 3C/4C types. Another objective of the present invention is to provide a bus architecture to perform the method for crosstalk elimination with fewer extra wires.

In order to achieve the objective, the present invention discloses a method for crosstalk elimination comprising the steps of: (1) deassembling a first piece of data to a plurality of data segments; (2) conducting a parallel crosstalk check on the data segments to form a second piece of data that is crosstalk-free; and (3) restoring the first piece of data based on the second piece of data. The method of the present invention further comprises the step of configuring a transmission bus, which comprises a plurality of wires, to a plurality of channels that are arranged in order. Step (2), conducting a parallel crosstalk check on the data segments to form the second piece of data, comprises the steps of: (2-1) checking the crosstalk induced between the data segments in the current cycle and the corresponding data segments transmitted in the previous cycle; (2-2) shifting the data segment from the current channel to the next channel, and (2-3) inserting an NOP segment into the current channel.

The present invention also discloses a bus architecture to perform the method for crosstalk elimination. The bus architecture comprises a deassembler configuring a first piece of data to a plurality of data segments and conducting a parallel crosstalk check on the data segments to form a second piece of data that is crosstalk-free, a transmission bus comprising a plurality of wires to transmit in parallel the second piece of data, and an assembler receiving the second piece of data to restore the first piece of data, wherein the wires are configured to form a plurality of channels arranged in series according to the data segments.

### BRIEF DESCRIPTION OF THE SEVERAL VIEWS OF THE DRAWINGS

The invention will be described according to the appended drawings.

FIG. 1 shows a schematic view of a traditional bus encoding scheme.

FIGS. 2(a) and 2(b) are schematic views illustrating the 4C crosstalk on three adjacent wires.

FIG. 3 is a schematic view of one embodiment of the bus architecture of the present invention.

FIG. 4(a) shows a schematic view of the flow chart of one embodiment of the method for crosstalk elimination of the present invention.

FIG. 4(b) shows a schematic view of the detailed steps of one step of FIG. 4(a).

FIG. 5(a) and FIG. 5(b) show schematic views of how the bus architecture is configured according to a deassembling mechanism.

FIG. 6 is a schematic view illustrating how the deassembler mechanism works.

FIGS. 7(a) and 7(b) show schematic views of six possible patterns to be transmitted with 1-bit separation flag.

FIGS. 8(a) and 8(b) show graph illustrations showing six possible patterns to be transmitted with 2-bit separation flag.

FIG. 9 is a schematic view illustrating a functional block diagram of the deassembler.

FIG. 10 is a schematic view illustrating one embodiment of the deassembler with four operation zones.

FIG. 11(a) shows a schematic view of one embodiment of the first operation zone.

FIG. 11(b) shows a schematic view of one embodiment of the second operation zone.

FIG. 12 is a schematic view illustrating one embodiment of the assembler.

FIG. 13 shows a graph illustration of the improvement rate of the total transmission time using the bus architecture of the present invention for different technologies.

FIG. 14 shows a graph illustration of the improvement in transmission rate using the bus architecture of the present invention with respect to different channel sizes and different technologies.

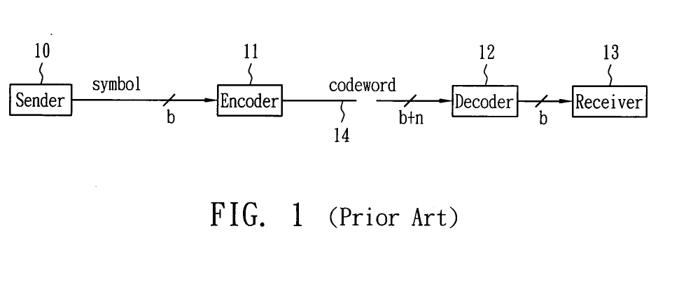

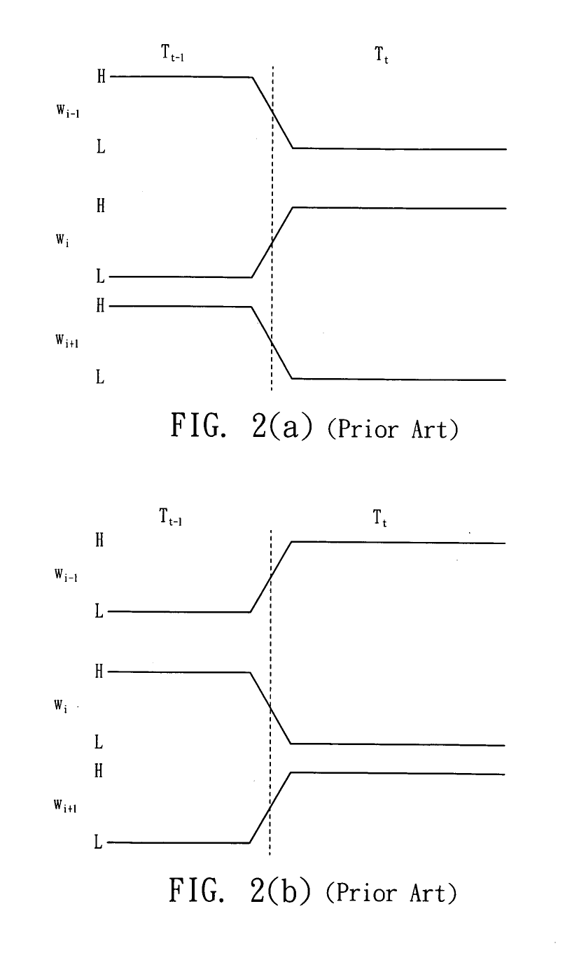

### DETAILED DESCRIPTION OF THE INVENTION

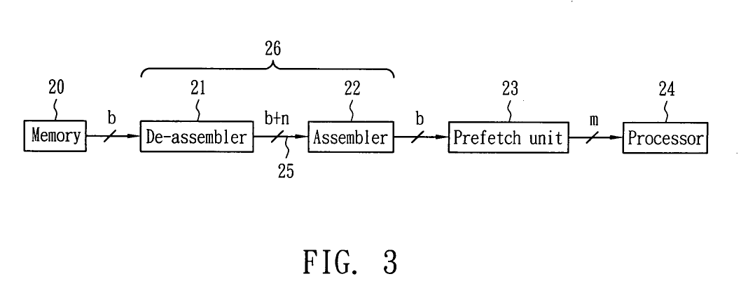

In order to explain the method for crosstalk elimination of the present invention more smoothly, a bus architecture is described that performs the method of the present invention. FIG. 3 is one embodiment of the bus architecture comprising a memory 20, a deassembler 21, an assembler 22, a prefetch unit 23, a processor 24 and a transmission bus 25. The deassembler 21 is designed to deassemble the b-bit data sent by the memory 20 into (b+n)-bit crosstalk-free data. Then the (b+n)-bit data is transmitted on the transmission bus 25. The assembler 22 is designed to assemble the (b+n)-bit data into the original b-bit data. Then the b-bit data is collected in the prefetch unit 23 and sent to the processor 24 on demand.

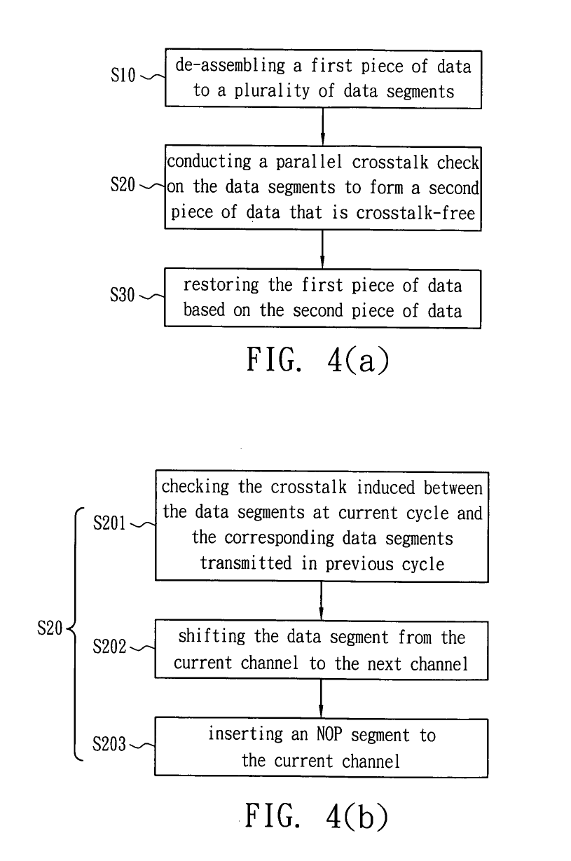

FIG. 4(a) shows the flow chart of one embodiment of the method of the present invention, which comprises deassembling a first piece of data to a plurality of data segments (S10), conducting a parallel crosstalk check on the data segments to form a second piece of data that is crosstalk-free (S20) and restoring the first piece of data based on the second piece of data (S30). The following describes the details of the method for crosstalk elimination of the present invention. The method of the present invention further comprises the step of configuring a transmission bus comprising a plurality of wires to a plurality of channels that is arranged in order. FIG. 4(b) shows the detailed steps of Step S20, which comprise checking the crosstalk induced between the data segments in the current cycle and the corresponding data segments transmitted in the previous cycle (S201), shifting the data segment from the current channel to the next channel (S202) and inserting an NOP segment into the current channel (S203).

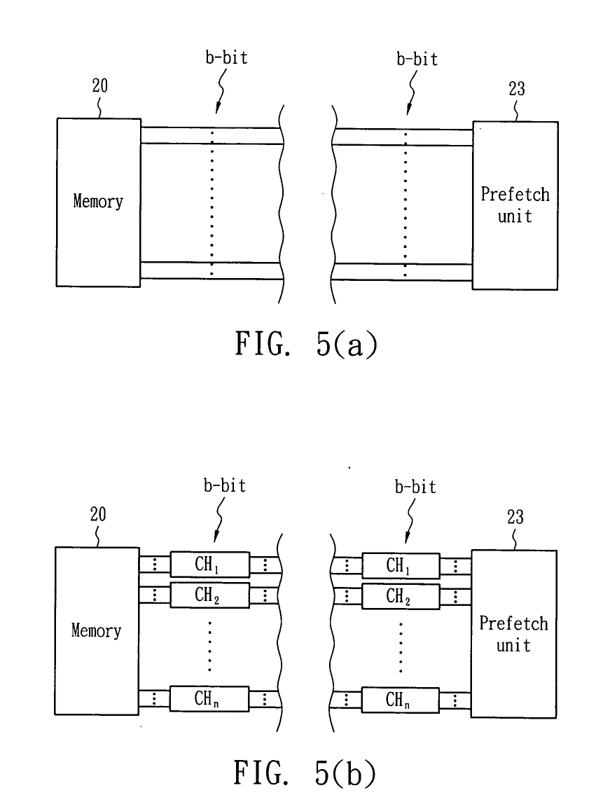

At Step S10, referring to FIGS. 5(a) and 5(b), the bus architecture of FIG. 3 except the deassembler 21, the assembler 22 and the transmission bus 25 is configured according to a deassembling mechanism. In FIG. 5(a), the bus connecting to the memory 20, which comprises b wires (i.e., b-bits), is partitioned into several channels, CH₁, CH₂, CHₙ, etc., as shown in FIG. 5(b). Also, the bus connecting to the prefetch unit 23, which comprises b wires (i.e., b-bits), is treated like the bus connecting to the memory 20. The data transmitted on a channel is referred to as a data segment, which is denoted as data_{t,i} where t is the time stamp and i is the channel position index. Each data segment is regarded as a basic data transmission unit.

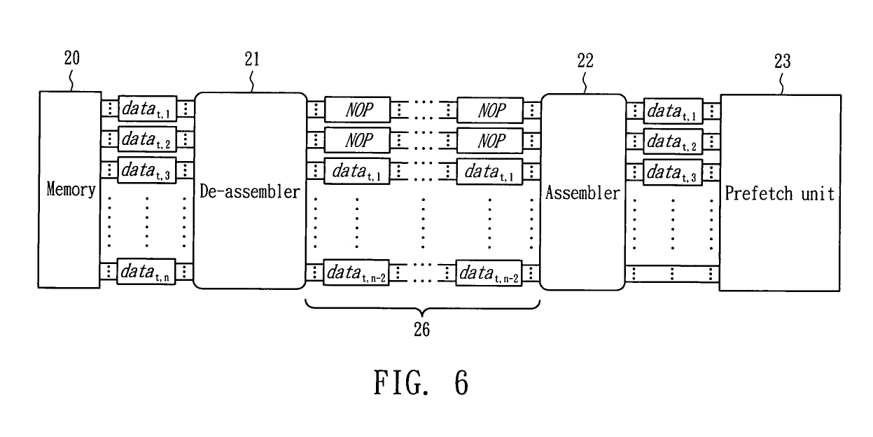

At Step S20, referring to FIG. 6, data_{t,1} represents the data segment to be sent on the first channel position in the current cycle, and data_{t-1,1} represents the data segment sent on the first channel position in the previous cycle, which was stored in storage elements (not shown) in the deassembler 21. When data transmission begins, data_{t,1} and data_{t-1,1} are checked to see if there is any 3C or 4C crosstalk. Similarly, on each channel, the crosstalk check is conducted on the data segment in the current cycle and the corresponding data segment transmitted in the previous cycle (i.e., S201). If no 3C or 4C crosstalk occurs, then the data segment is transmitted on the current channel. Otherwise, the data segment data_{t,i} is shifted from the current channel to the next channel position CHᵢ₊₁ (i.e., S202) and a data segment comprising all 0's or all 1's, called an NOP segment, is inserted onto the channel CHᵢ (i.e., S203) in order to eliminate the 3C/4C crosstalk. For example, if there is a 3C or 4C crosstalk induced between data_{t,1} and data_{t-1,1}, then data_{t,1} will be shifted to the next channel position CH₂ and an NOP segment will be inserted onto the channel CH₁. Note that patterns comprising 0's (or 1's) will not incur 3C/4C with any other patterns. Once data_{t,i} is shifted to channel CHᵢ₊₁, it must be checked with data_{t-1,i+1} to see if there is any crosstalk occurring between them. The crosstalk check continues until data_{t,i} finds a position channel CHⱼ, where data_{t,i} and data_{i-1,j} have no crosstalk, or it reaches the last channel of the transmission bus 25. Those data segments that cannot be sent in the current cycle due to the NOP segment insertion would be shifted to the next transmission cycle. For example, in FIG. 6, data_{t,1} has 3C/4C crosstalk with data_{t-1,1} and data_{t-1,2}. Then data_{t,1} is shifted two channel positions and will be sent at position CH₃. Since the data segments are shifted two channel positions, they would be transmitted in the next transmission cycle.

At Step S30, it is necessary to remove all the inserted NOP segments and pack the valid data segments using the assembler 22. After the packing, the assembler 22 would inform the processor 23 of the number of completed instructions in the current cycle. Those data segments, which cannot be packed into a complete instruction, will be stored in a buffer queue to wait for the next assembling processing.

Note that the worst case of transmission time happens when the 3C or 4C crosstalk occurs between data_{t,1} and every data segment transmitted in the previous cycle. In this case, the transmission bus 25 is filled with all the NOP segments in the current cycle transmission. However, since NOP segments do not result in crosstalk with any other data patterns, all data segments can be sent without incurring any 3C/4C crosstalk patterns in the next transmission cycle. Therefore, the worst case is to double the transmission cycles, that is, one cycle for data segments transmission and one cycle for NOP segments alternately.

Since the crosstalk may occur across the boundary of two adjacent data segments, shielding wires have to be inserted between every pair of data segments. Moreover, whether a data segment pattern of all 0 bits (or all 1 bits) is an NOP segment or a real data segment requires a mechanism to make the distinction. Therefore, the method of the present invention further comprises the step of inserting a separation flag (sf) between every pair of the data segments, which are used for shielding the data segments and for identifying the NOP segment. How to design the separation flag is described below in detail.

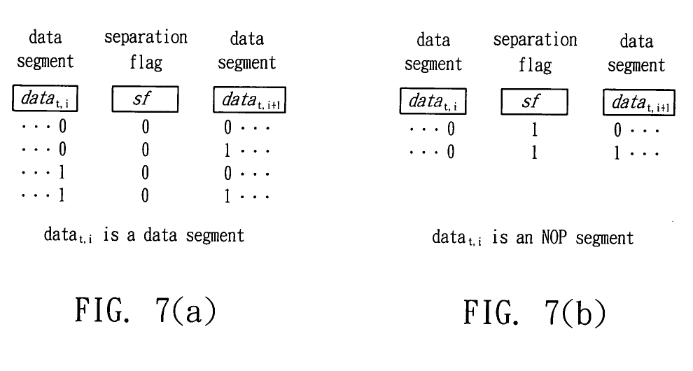

For the shielding purpose of the separation flag, it is easy to select one bit for the separation flag, which is set to be 0 (or 1) for all patterns to achieve the shielding purpose. It works in the same manner as inserting a stable ground (or Vdd) wire between each pair of data segments. In addition, to decide whether the data segment sent is an NOP segment of a real data segment, the separation flag should have at least two states. Suppose that the NOP segment is represented as all 0's, and the separation flag are responsible to remember the type of data segment followed by the separation flag. That is, for a pattern (0-s-X), where 0 represents the last bit of data_{t,i}, sf represents the separation flag, and X (0 or 1) represents the first bit of data_{t,i+1}. The separation flag, sf, should be set to tell whether the 0's are a part of the NOP segment or the real data segment. An obvious answer is to set s to be 0 for the real data segment and to set s to be 1 for the NOP segment. Unfortunately, this selection will result in the 3C/4C crosstalk sequence between the data segments and the separation flag. FIGS. 7(a) and 7(b) show six possible patterns to be transmitted on the transmission bus where the four combinations, (0-0-0), (0-0-1), (1-0-0) and (1-0-1), in FIG. 7(a) represent data_{t,i} being a data segment and the two combinations, (0-1-0), (0-1-1), in FIG. 7(b) represent data_{t,i} being an NOP segment. The separation flag sf are responsible to remember the data segment data_{t,i}. Obviously, patterns (1-0-1) followed by (0-1-0), (1-0-1) followed by (0-1-1), (0-1-0) followed by (0-0-1), (1-0-0) followed by (0-1-0), etc., incur the 3C/4C crosstalk (refer to Table 1). The separation flag in FIGS. 7(a) and 7(b) is 1-bit.

It is said that a set of bit-patterns is crosstalk-free cyclic if any pair of the patterns in the set does not incur the 3C/4C crosstalk. For example, a set of patterns, (000, 001, 100, 101, and 111) is crosstalk-free cyclic. Hence, in addition to acting as a state-remembering bit, the separation flag together with the last bit of data_{t,i}, and the first bit of data_{t,i+1} must be designed to be crosstalk-free cyclic. It is shown below how to choose appropriate separation flag to form a (|sf|+2)-bit crosstalk-free cyclic, where |sf| is the length of the separation flag and the number “2” means the last bit of data_{t,i} and the first bit of data_{t,i+1}. In FIGS. 7(a) and 7(b), there are six possible patterns to be identified, so it is needed to find a set of codes which is crosstalk-free cyclic and at least six in size. For |sf|=1, the maximum size of crosstalk-free cyclic codes is only five, that is, 000, 001, 100, 101, and 111. These codes are not enough to accommodate six different patterns. Let the size of s be two. The maximum number of crosstalk-free cyclic codes is now over six. In fact, for |sf|=2, there is more than one choice to design the separation flag. Table 2 shows four possible choices of the separation flag.

TABLE 2

| | |
|---|---|
| NOP segment = all 0's | NOP segment = all 1's |

| S_{data} | Sₙₒₚ | S_{data} | Sₙₒₚ |
|---|---|---|---|
| 10 | 00 | 00 | 10 |
| 11 | 01 | 01 | 11 |

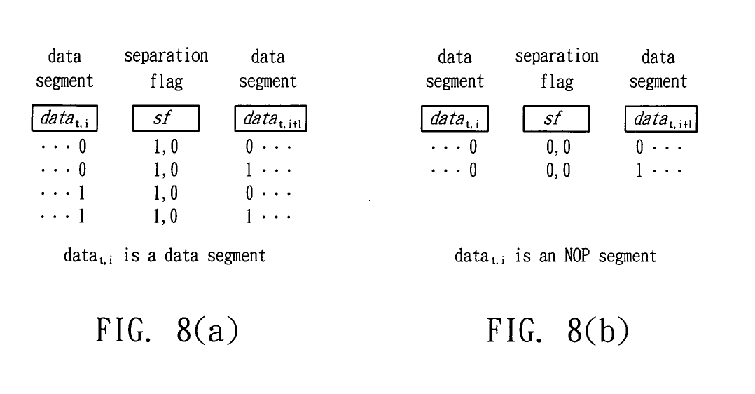

When the NOP segment is designed to be all 0's, two codes for the separation flag can be used. The first choice is to have s=10 for data_{t,i} being a data segment and s=00 for data_{t,i} being an NOP segment. The second choice is to have s=11 for data_{t,i} being a data segment and s=01 for data_{t,i} being an NOP segment. Similarly, if the NOP segment is designed to be all 1's, two codes for the separation flag, (00, 10) and (01, 11), can be used. FIG. 8(a) together with 8(b) show an example of using all 0's, (0 . . . 0), as an NOP segment and the selected codes for the separation flag are (10,00) pair. In this example, the first two patterns of FIG. 8(a), (0-1-0-0) and (0-1-0-1), tell that data_{t,i} is a real data segment, and the two patterns of FIG. 8(b), (0-0-0-0) and (0-0-0-1), tell that data_{t,i} is an NOP segment. Moreover, the six patterns are crosstalk-free cyclic. Finally, one special condition is designed for the last channel position CHₙ. Since the last channel has no adjacent channel, only one bit is required to decide whether the data sent on the last channel position is an NOP segment or not.

The bus architecture of the present invention is described below. Referring back to FIG. 3, the bus architecture 26 of the present invention comprises a deassembler 21, a transmission bus 25 and an assembler 22. The deassembler 21 configures a first piece of data to a plurality of data segments and conducts a parallel crosstalk check on the data segments to form a second piece of data that is crosstalk-free. The transmission bus 25 comprises a plurality of wires to transmit in parallel the second piece of data, where the wires are configured to form a plurality of channels arranged in series according to the data segments. The assembler 22 receives the second piece of data to restore the first piece of data.

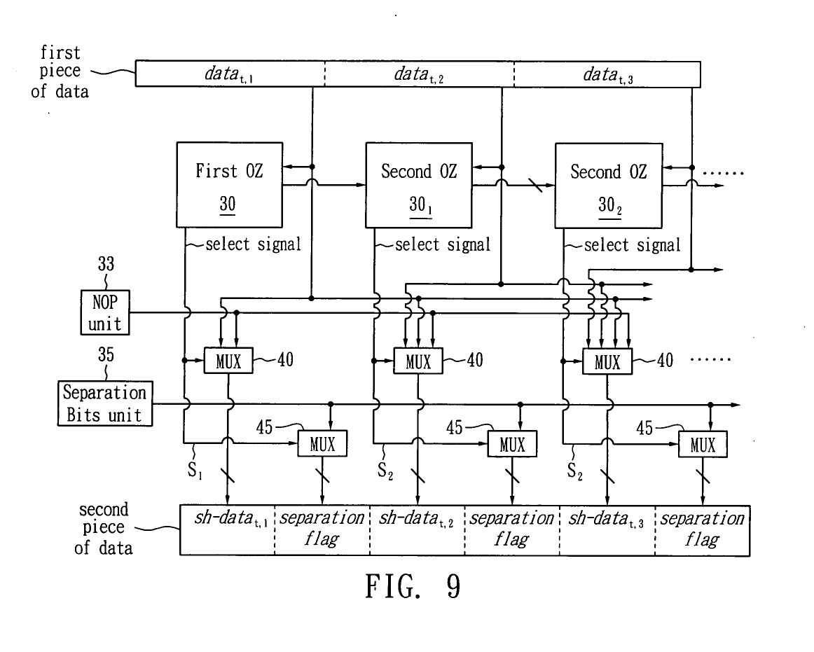

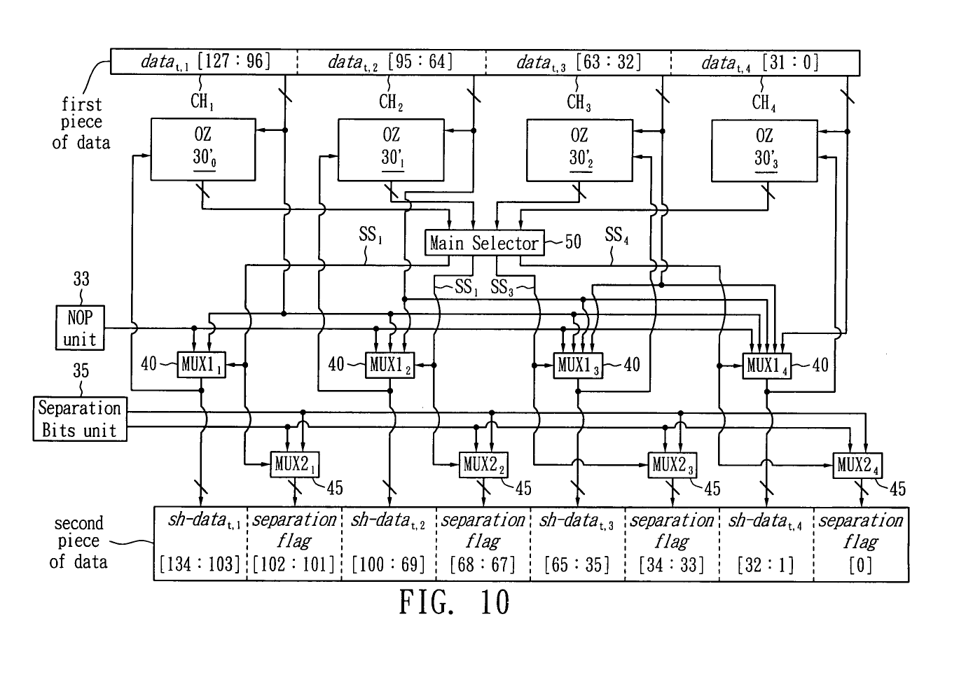

FIG. 9 illustrates a functional block diagram of the deassembler 21. The deassembler 21 comprises: (1) a first operation zone (First OZ) 30 receiving the data segment on the first channel (data_{t,1}), (2) a plurality of second operation zones (Second OZ) 30ᵢ (i is a positive integer), each receiving the corresponding data segments data_{t,i+1}, (3) a plurality of first multiplexers 40 receiving an NOP segment from an NOP unit 33 and the associated data segments to generate a shifted data segment sh-data_{t,i}, and (4) a plurality of second multiplexers 45, each receiving separation flag from a separation bit unit 35 to incorporate into the corresponding shifted data segment sh-data_{t,i}. The First OZ 30 and the second OZ 30ᵢ conduct a parallel crosstalk check on the data segments. The select signals of the first multiplexers 40 and the second multiplexers 45 come from the corresponding operation zones. All the shifted data segments sh-data_{t,i} and the separation flag form the second piece of data.

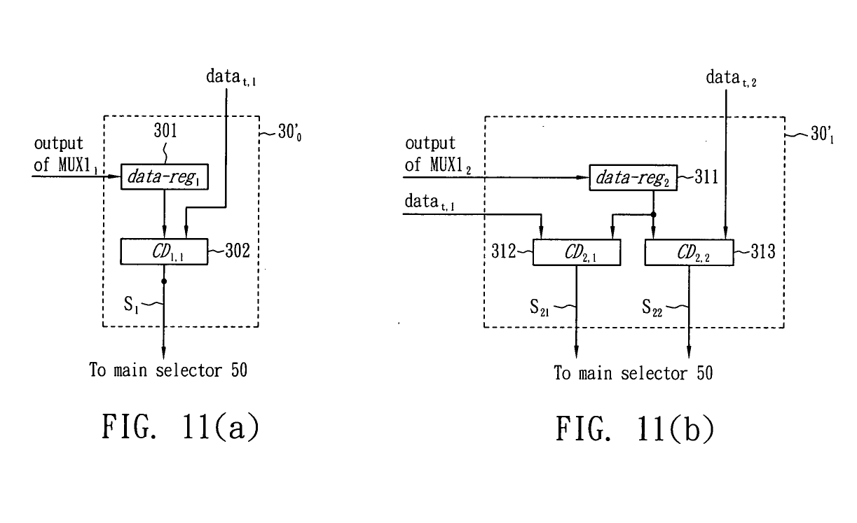

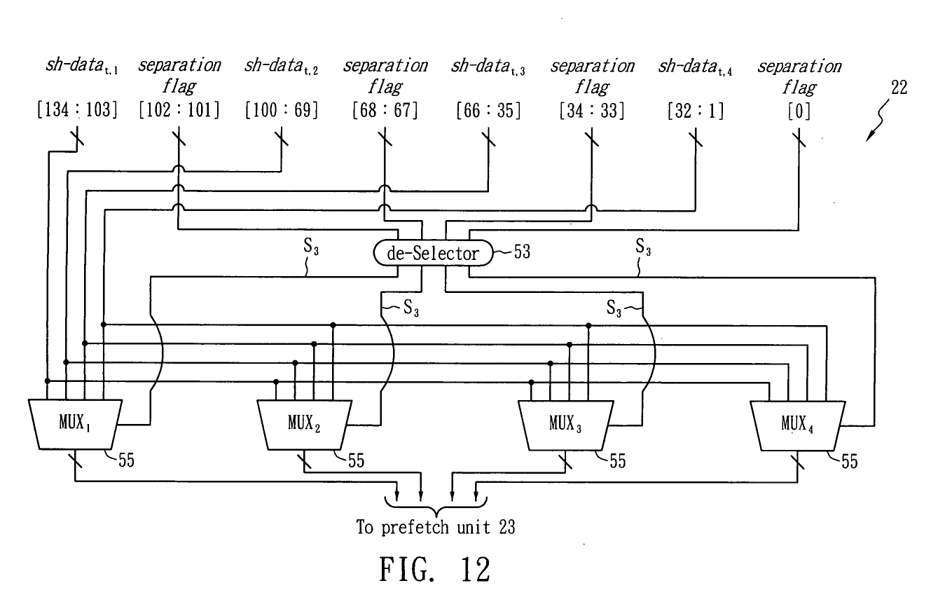

FIG. 10 illustrates one embodiment of the deassembler 21 with four operation zones, which receives a first piece of data of 128 bits. In the current embodiment, the width of the bus connecting the memory 20 and the deassembler 21 (refer to FIG. 3) is 128 bits and the width of each channel is configured to be 32 bits. Hence, the first piece of data of 128 bits is grouped as four data segments, data_{t,1}, data_{t,2}, data_{t,3} and data_{t,4}, with bits from 127 to 96, from 95 to 64, from 63 to 32, and from 31 to 0, respectively, shown at the top of FIG. 10. In addition, the aforesaid four data segments, data_{t,1}, data_{t,2}, data_{t,3} and data_{t,4}, are associated with channels CH₁, CH₂, CH₃, and CH₄, respectively. The deassembler 21 comprises: (1) four operation zones (OZ) 30′₀, 30′₁, 30′₂, and 30′₃; (2) four first multiplexers 40 (i.e., MUX1₁-MUX1₄), (3) one main selector 50, and (4) four second multiplexers 45 (i.e., MUX2₁-MUX2₄). The deassembler 21 exhibits a parallel checking structure to conduct a crosstalk check on the data segments (data_{t,i}) to be sent in the current cycle and the data segment already sent in the previous cycle (data_{t-1,j}) in parallel rather than sequentially. Each operation zone corresponding to the channel CHᵢ, comprises a data_register data_regᵢ and |i| cross_detector CD_{i,j}, for j from 1 to i (refer to FIGS. 11(a) and 11(b)). It means there are one data_register data_reg₁ and one cross_detector CD_{1,1} in the OZ 30′₀; there are one data_register data_reg₂ and two cross_detectors CD_{2,1}, CD_{2,2} in the OZ 30′₁; there are one data_register data_reg₃ and three cross_detectors CD_{3,1}, CD_{3,2}, CD_{3,3} in the OZ 30′₂, and so on. Note that the channels CH₁, CH₂, CH₃ and CH₄ correspond to the OZs 30′₀, 30′₁, 30′₂, and 30′₃, respectively. The data_regᵢ is designed to store the data segment sent on CHᵢ in the previous cycle. The CD_{i,j}, where j from 1 to i, is a combinational logic used to check if data_regᵢ and data_{t,j} induce crosstalk. In other words, for a data_regᵢ, it is checked with al data segments data_{t,j} to be sent, for j from 1 to i. The main selector 50 receives directly all the output signals of the cross_detectors in the four OZs (30′₀-30′₃) as input signals. In addition, four output signals of the main selectors 50 are provided, as the select signals (SS₁-SS₄), to the corresponding first multiplexers 40 (i.e., MUX1₁—i.e., MUX1₄) and the corresponding second multiplexers 45 (i.e., MUX2₁—i.e., MUX2₄).

FIG. 11(a) shows one embodiment of the OZ 30′₀. The OZ 30′₀ comprises a first data_register data_reg₁ 301 receiving and storing the data segment in the previous cycle, data_{t-1,1}, which is the output of MUX1₁, and a first cross_detector CD_{1,1} 302 designed to detect if crosstalk occurs between the current data segment, data_{t,1} and the data segment on CH₁ in the previous cycle, data_{t-1,1}. Then the first cross_detector CD_{1,1} 302 generates a first select signal S₁ sent to the main selector 50. FIG. 11(b) shows one embodiment of the OZ 30′₁. The OZ 30′₁ comprises: (1) a data_register data_reg₂ 311 receiving and storing the data segment in the previous cycle, data_{t-1,2}, which is the output of MUX 12, (2) a cross_detector CD_{2,1} 312 designed to detect if crosstalk occurs between the data segment on CH₂ in the previous cycle, data_{t-1,2}, and the current data segment data_{t,1} on CH₁, (3) a cross_detector CD_{2,2} 313 designed to detect if crosstalk occurs between the data segment on CH₂ in the previous cycle, data_{t-1,2} and the current data segment, data_{t,2}. Two second select signals S₂₁ and S₂₂ generated by the cross_detector CD_{2,1} 312 and the cross_detector CD_{2,2} 313, respectively, are sent to the main selector 50. Referring back to FIG. 10, the second piece of data comprises four shifted data segments and four separation flag, which are the outputs of the first multiplexers 40 and the second multiplexers 45, respectively.

FIG. 12 illustrates one embodiment of the assembler 22. The assembler 22 is designed to remove the NOP segments in the second piece of data to restore the first piece of data, which comprises a deselector 53 and a plurality of third multiplexers 55 (in the current embodiment, there are four multiplexers). The deselector 53 receives the separation flag and generates a plurality of third select signals S₃ to the third multiplexers 55 (i.e., MUX₁-MUX₄). The separation flag records the information to distinguish the data segment from the NOP segment. Each third multiplexer MUXᵢ 55 receives all the corresponding shifted data segments in the second piece of data and the corresponding third select signal S₃ representing the number of the channel positions to be left-shifted for each data segment and is used to determine which shifted data segment is outputted. The outputs of the third multiplexers 55 form the first piece of data; that is, the first piece of data is restored.

Table 3 shows the timing analysis of wire and the deassembly 21/assembler 22. An instruction bus is taken as the demonstration example, and the sim-outorder simulator from Simplescalar 3.0 (refer to the website of http://www.simplescalar.com) is incorporated with the bus architectures of the present invention to simulate the out-of-order 4-issue superscalar architecture without caches. In the simulation, each instruction is 32-bit long, and four instructions are issued in parallel so that the total bus width is 128 bits. Four different channel sizes: 4-bit per channel, 8-bit per channel, 16-bit per channel and 32-bit per channel are simulated. In Table 3, DSPstone is adopted as the benchmarks. The case of 128-bit bus width with 32-bit per channel is first taken as an example for analysis and then the comparison of all different channel sizes is presented.

TABLE 3

| | Bus | | | | | | | | |
|---|---|---|---|---|---|---|---|---|---|
| tech | length | 0C | 1C | 2C | 3C | 4C | deassembler | assembler | ratio(%) |
| 100 nm | 10 mm | 1.00 | 1.94 | 5.91 | 6.64 | 7.57 | 0.51 | 0.22 | 12.15 |
| | 15 mm | 1.00 | 1.89 | 6.08 | 7.14 | 8.50 | 0.24 | 0.10 | 24.40 |
| | 20 mm | 1.00 | 1.73 | 5.21 | 6.62 | 7.66 | 0.12 | 0.05 | 29373 |
| 70 nm | 10 mm | 1.00 | 1.61 | 4.28 | 5.11 | 5.87 | 0.26 | 0.11 | 20.83 |
| | 15 mm | 1.00 | 1.57 | 4.49 | 6.39 | 8.04 | 0.12 | 0.05 | 41.98 |
| | 20 mm | 1.00 | 1.74 | 4.84 | 7.58 | 9.86 | 0.08 | 0.03 | 49.77 |

The simulation regarding Table 3, which is performed with Spice (refer to “Spice: A computer program to simulate computer circuits” by L. Nagel, University of California, Berkeley UCBERL Memo M520, May 1995), is to show how much performance improvement can be obtained by eliminating 3C and 4C crosstalk. The values of capacitances for C_{grounded} and C_{couple} in different technologies are obtained from the Berkeley predictive technology model (BPTM) (refer to the website of http://www-device.eecs.berkeley.edu/ptm). In Table 3, the first column gives the process technology (70 nm and 100 nm). The second column gives different bus lengths (10 mm, 15 mmm and 20 mm). The third to the seventh columns report the wire delay without crosstalk (the third column) and with crosstalk (the fourth to seventh columns). The next two columns report the critical path delay for the deassembler and the assembler. All the delay information is normalized to the wire delay without crosstalk (i.e., the column labeled 0C). The last column reports the improvement ratio of the bus architecture of the present invention; it is calculated by formula (2) below.

1−[(2C wire delay+deassembler delay+assembler delay)/4C wire delay]×100% (2)

From Table 3, first, the wire delay with 3C/4C crosstalk becomes more serious as the process technology scales down and as the bus length increases. For example, the wire delay with 4C crosstalk is about twice that with only the 2C crosstalk when the bus length is longer than 15 mm in 70 nm technology (e.g., 9.86 by 4C and 4.84 by 2C when the bus length is 20 mm in 70 nm technology). In addition, the extra delay caused by the deassembler and assembler is less significant when the bus length increases. Adding the delay time for bus transmission, deassembler and assembler all together, the improvement rate is about 30% in 100 nm technology and 50% in 70 nm technology when the bus length is 20 mm.

Table 4 below shows the cycle count overhead for channel size equal to 32. The experiment regarding Table 4 is to understand how many extra cycles are needed to execute a program. In Table 4, the columns labeled TCC and pen are the total cycle count of the original circuit and the cycle penalty using the bus architecture of the present invention, respectively. In the worst case, the cycle count overhead is only 0.5% (i.e., complex_update).

TABLE 4

channel size = 32

| benchmark | TCC | pen | ratio (%) |
|---|---|---|---|
| complex_multiply | 2290 | 6 | 0.26 |
| complex_update | 2396 | 12 | 0.50 |
| convolution | 3163 | 9 | 0.28 |
| dot_product | 2355 | 5 | 0.21 |
| fir2dim | 12084 | 22 | 0.18 |
| fir | 3702 | 3 | 0.08 |
| iir_biquad_N_sections | 3552 | 3 | 0.37 |
| iir_biquad_one_section | 2313 | 10 | 0.43 |
| lms | 4010 | 6 | 0.15 |
| matrix | 44360 | 11 | 0.02 |
| matrixlx3 | 2841 | 5 | 0.18 |
| n_complex_updates | 5662 | 32 | 0.21 |
| n_real_update | 3966 | 11 | 0.28 |
| real_update | 2282 | 9 | 0.39 |
| average | | | 0.25 |

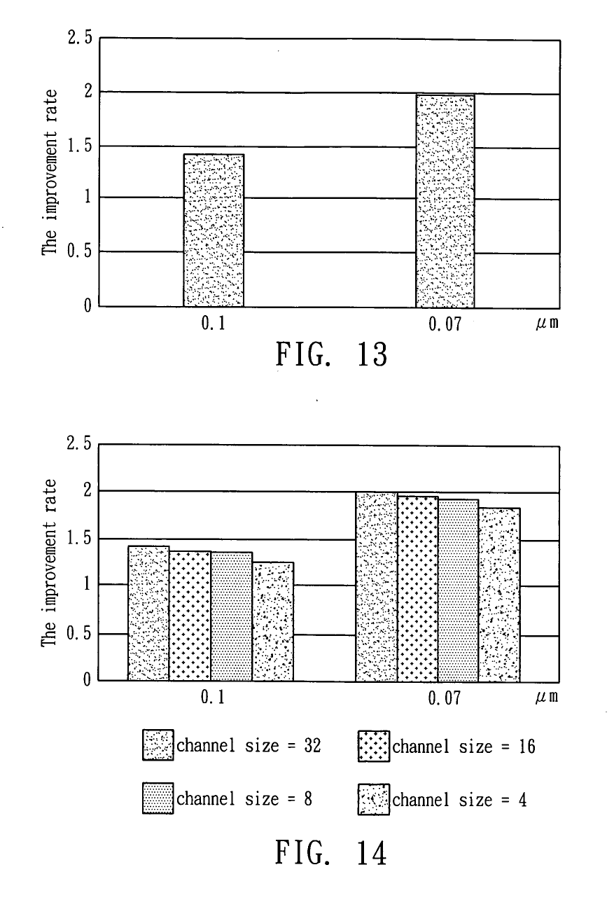

FIG. 13 shows the improvement rate of the total transmission time for different technologies in the case of 128-bit bus width with 32-bit per channel. The improvement in transmission rate is calculated by formula (3) below.

improvement rate=(orig_{—}tcc)/(new_{—}tcc×rate)×100% (3)

where orig_tcc and new_tcc are the total transmission cycle count of the original circuit and the new circuit that uses the bus architecture of the present invention, respectively, and rate is the transmission length reduction rate for different technologies. From FIG. 13, the improvement rate of the total transmission time for 100 nm technology is about 1.4 and that for 70 nm technology is about 2 when the bus length is 20 nm.

Table 5 below shows the comparisons of the simulated area overheads of the present invention (labeled as PI) to Victor's memoryless approach (labeled as Victor). The area overhead includes the area of the deassembler/assembler and the extra wires required for the separation flag. As for circuits overhead, the above two circuits are designed using Verilog and synthesized by the Synopsys Design Compiler. The gate count is obtained by synthesizing circuits using only NOR gate and inverter, and the area is synthesized with the TSMC 0.13 μm cell library. The result of Table 5 shows the deassembler used in the present invention takes more area than the encoder in Victor's memoryless approach. This overhead is mainly from the logic for cross_detectors. In addition, storage elements are needed in the present invention because the data segments transmitted in the previous cycle are required to be stored. As to the required extra wires, the number of extra wires used in the present invention is only seven as compared to the 85 extra wires needed for the practical cases proposed by Victor. The worst-case scenario is to transmit real data segments and all NOP segments alternately. It would cause up to 50% of total transmitted data to be NOP segments. However, this worst case hardly happens since the amount of bit-inducing crosstalk takes up a very small portion of all bit transmission.

TABLE 5

| area type | | | PI | Victor |
|---|---|---|---|---|
| logic circuit | Deassembler/ | gate count | 9794 | 885 |
| | Encoder | area (μm) | 14792.97 | 2359.30 |
| | | storage element | 128 | 0 |
| | | (bit) | | |
| | Assembler/Decoder | gate count | 879 | 1402 |
| | | area (μm) | 2053.854 | 3381.22 |

| | | |
|---|---|---|
| # extra wires (bit) | 7 | 85 |

Table 6 below shows the ratio of NOP segment insertions to the total number of segments sent. It can be seen that even in the worst case, the average NOP segment inserted ratio is about 30%.

TABLE 6

| | channel size = 32 | | |
|---|---|---|---|
| | | | overhead |
| benchmark | #Total | #NOP | (%) |
| complex_multiply | 6460 | 1970 | 30.50 |
| complex_update | 6664 | 2022 | 30.34 |
| convolution | 8748 | 2725 | 31.15 |
| dot_product | 6652 | 2025 | 30.44 |
| fir2dim | 30860 | 9976 | 32.33 |
| fir | 10032 | 3169 | 31.59 |
| iir_biquad_N_sections | 9864 | 2977 | 30.18 |
| iir_biquad_one_section | 6516 | 1969 | 30.22 |
| lms | 11016 | 3447 | 31.29 |
| matrix | 7900 | 2414 | 30.56 |
| matrixlx3 | 109908 | 31735 | 28.87 |
| n_complex_updates | 13656 | 4305 | 31.52 |
| n_real_update | 10760 | 3413 | 31.72 |
| real_update | 6468 | 1943 | 30.04 |
| average | | | 30.77 |

TABLE 7

| | | Channel size | | | | | | | |
|---|---|---|---|---|---|---|---|---|---|
| | | 4 | | 8 | | 6 | | 32 | |
| benchmark | TCC | pen | ratio(%) | pen | ratio(%) | pen | ratio(%) | pen | ratio(%) |
| complex_multiply | 2290 | 4 | 0.17 | 1 | 0.04 | 2 | 0.09 | 6 | 0.26 |
| complex_update | 2396 | 3 | 0.13 | 1 | 0.04 | 4 | 0.17 | 12 | 0.50 |
| convolution | 3163 | 4 | 0.13 | 1 | 0.32 | 2 | 0.06 | 9 | 0.28 |
| dot_product | 2355 | 2 | 0.08 | 0 | 0 | 3 | 0.13 | 5 | 0.21 |
| fir2dim | 12084 | 4 | 0.03 | 1 | 0.08 | 7 | 0.06 | 22 | 0.18 |
| fir | 3702 | 4 | 0.11 | 5 | 0.01 | 1 | 0.02 | 3 | 0.08 |
| iir_biquad_N_sections | 3552 | 5 | 0.14 | 4 | 0.11 | 2 | 0.06 | 3 | 0.37 |
| iir_biquad_one_section | 2313 | 4 | 0.17 | 2 | 0.08 | 3 | 0.13 | 10 | 0.43 |
| lms | 4010 | 4 | 0.09 | 3 | 0.07 | 5 | 0.12 | 6 | 0.15 |
| matrix | 44360 | 4 | 0.01 | 4 | 0.01 | 27 | 0.06 | 11 | 0.02 |
| matrixlx3 | 2841 | 1 | 0.14 | 2 | 0.07 | 3 | 0.11 | 5 | 0.18 |
| n_complex_updates | 5662 | 3 | 0.05 | 0 | 0 | 4 | 0.07 | 2 | 0.21 |
| n_real_update | 3966 | 3 | 0.08 | 1 | 0.02 | 3 | 0.08 | 11 | 0.28 |
| real_update | 2282 | 1 | 0.05 | 2 | 0.88 | 4 | 0.18 | 9 | 0.39 |
| average | | | 0.10 | | 0.12 | | 0.09 | | 0.25 |

Table 7 above shows the effects of different channel widths using the architecture of the present invention. The simulation is conducted to compare the cycle count, the improvement in transmission rate, the NOP segment overhead and the number of extra wire insertions for four different channel sizes (4-bit per channel, 8-bit per channel, 16-bit per channel and 32-bit per channel). The number of extra cycles needed to execute a program is shown in Table 7. It can be seen that there is almost no cycle count overhead (less than 1%) for all channel sizes.

FIG. 14 shows the improvement in transmission rate using the bus architecture of the present invention with respect to different channel sizes and different technologies. The improvement rate for different cases is at least 1.5 in 100 nm technology and at least 1.8 in 70 nm technology. The improvement rate is less significant when the channel size becomes smaller. This is because the selectors in the deassembler and the deselector in the assembler in small channel size cases are more complex than those in large channel size cases.

For the number of extra wire insertions (i.e., for separation flag), Table 8 below shows the comparisons of the method of the present invention to Victor's memoryless approach. Four cases for different channel sizes using the method of the present invention (labeled as PI) and two cases presented by Victor are shown. The results show that when the number of bus width becomes wider, the effectiveness of the method of the present invention becomes more significant. For example, when the bus width is 128 and the channel size is 32, the number of extra wires using the method of the present invention is only seven as compared to the 59 and 85 extra wires needed for the theoretical and practical cases, respectively.

TABLE 8

| | PI | | | | | |
|---|---|---|---|---|---|---|
| | channel size | | | | Victor | Victor |
| bus width | 4 | 8 | 16 | 32 | theorectical | practical |
| 32 | 15 | 7 | 3 | 1 | 14 | 21 |
| 64 | 31 | 15 | 7 | 3 | 28 | 45 |
| 128 | 63 | 31 | 15 | 7 | 59 | 85 |

Tables 9 and 10 below show the ratio of NOP segment insertions to the total number of segments sent. It can be seen that about 10% of NOP segments for the channel size of 4 and 20% for the channel size of 8 have been inserted.

TABLE 9
(NOP segment overhead for channel size 4 and 8)

| | channel size | | | | | |
|---|---|---|---|---|---|---|
| | 4 | | | 8 | | |
| benchmark | #Total | #NOP | overhead(%) | #Total | #NOP | overhead(%) |
| complex_multiply | 40576 | 4060 | 10.01 | 21968 | 4100 | 18.66 |
| complex_update | 41760 | 4314 | 10.33 | 22512 | 4086 | 18.15 |
| convolution | 52192 | 5095 | 9.76 | 28496 | 5331 | 18.71 |
| dot_product | 41792 | 4274 | 1.023 | 22640 | 4150 | 18.33 |
| fir2dim | 179104 | 19641 | 10.97 | 98016 | 19776 | 20.18 |
| fir | 59168 | 6081 | 10.28 | 32688 | 6299 | 19.27 |
| iir_biquad_N_sections | 60416 | 6358 | 10.52 | 32560 | 6008 | 18.45 |
| iir_biquad_one_section | 40992 | 4212 | 10.28 | 22192 | 4091 | 18.43 |
| lms | 66208 | 7746 | 11.70 | 36032 | 7074 | 19.63 |
| matrix | 49216 | 4941 | 10.04 | 26576 | 4788 | 18.02 |
| matrixlx3 | 654144 | 71991 | 11.01 | 348288 | 62126 | 17.84 |
| n_complex_updates | 78208 | 8083 | 10.34 | 42640 | 7935 | 18.61 |
| n_real_update | 62880 | 6583 | 10.47 | 34144 | 6281 | 18.40 |
| real_update | 40704 | 4154 | 10.21 | 21984 | 3998 | 18.19 |
| average | | | 10.44 | | | 18.63 |

TABLE 10
(NOP segment overhead for channel 16 and 32)

| | channel size | | | | | |
|---|---|---|---|---|---|---|
| | 16 | | | 32 | | |
| benchmark | #Total | #NOP | overhead(%) | #Total | #NOP | overhead(%) |
| complex_multiply | 11816 | 2917 | 24.69 | 6460 | 1970 | 30.50 |
| complex_update | 12120 | 2920 | 24.09 | 6664 | 2022 | 30.34 |
| convolution | 15608 | 3861 | 24.74 | 8748 | 2725 | 31.15 |
| dot_product | 12000 | 2851 | 23.76 | 6652 | 2025 | 30.44 |
| fir2dim | 54272 | 14518 | 26.75 | 30860 | 9976 | 32.33 |
| fir | 17776 | 4651 | 26.16 | 10032 | 3169 | 31.59 |
| iir_biquad_N_sections | 17808 | 4400 | 24.71 | 9864 | 2977 | 30.18 |
| iir_biquad_one_section | 11864 | 2844 | 23.97 | 6516 | 1969 | 30.22 |
| lms | 19640 | 5098 | 25.96 | 11016 | 3447 | 31.29 |
| matrix | 14312 | 3481 | 24.32 | 7900 | 2414 | 30.56 |
| matrixlx3 | 199408 | 55274 | 27.72 | 109908 | 31735 | 28.87 |
| n_complex_updates | 23656 | 6047 | 25.56 | 13656 | 4305 | 31.52 |
| n_real_update | 18664 | 4618 | 24.74 | 10760 | 3413 | 31.72 |
| real_update | 11840 | 2852 | 24.09 | 6468 | 1943 | 30.04 |
| average | | | 25.09 | | | 30.77 |

The method for crosstalk elimination of the present invention conducts a parallel check and shifts the data segments to the next channel to eliminate the crosstalk of 3C/4C, which is based on the bus architecture comprising a deassembler and an assembler disposed on both ends of the transmission bus. According to the simulation results above, the method of the present invention achieves about 1.8 times performance improvement rate with fewer extra wires as compared with the prior arts in 70 nm technology.

The above-described embodiments of the present invention are intended to be illustrative only. Numerous alternative embodiments may be devised by persons skilled in the art without departing from the scope of the following claims.

We claim:

1. A method for crosstalk elimination, comprising the steps of:
deassembling a first piece of data to a plurality of data segments;
conducting a parallel crosstalk check on the data segments to form a second piece of data that is crosstalk-free; and
restoring the first piece of data based on the second piece of data.

2. The method for crosstalk elimination of claim 1, further comprising the step of:
configuring a transmission bus being comprised of a plurality of wires to a plurality of channels arranged in series.

3. The method for crosstalk elimination of claim 2, wherein the step of conducting the parallel crosstalk check on the data segments comprises the steps of:
checking crosstalk induced between the data segments in a current cycle and corresponding data segments transmitted in a previous cycle;
shifting the data segment from a current channel to a next channel; and
inserting an NOP segment into said current channel.

4. The method for crosstalk elimination of claim 3, further comprising the step of:
shifting the data segment that cannot be sent in the current cycle to a next transmission cycle.

5. The method for crosstalk elimination of claim 2, further comprising the step of:
inserting a separation flag between every pair of the data segments, shielding the data segments and identifying the NOP segment.

6. The method for crosstalk elimination of claim 5, wherein the separation flag, a last bit of the data segment on the current channel and the first bit of the data segment on the next channel form a set of bit-patterns, the set of bit-patterns being crosstalk-free cyclic.

7. The method for crosstalk elimination of claim 3, wherein the channels transmit the data segments and the NOP segments.

8. A bus architecture for crosstalk elimination, comprising:
a deassembler configuring a first piece of data to a plurality of data segments and conducting a parallel crosstalk check on the data segments to form a second piece of data that is crosstalk-free;
a transmission bus comprising a plurality of wires to transmit in parallel the second piece of data, wherein the wires are configured to form a plurality of channels arranged in series according to the data segments; and
an assembler receiving the second piece of data to restore the first piece of data.

9. The bus architecture for crosstalk elimination of claim 8, wherein the deassembler comprises:
a first operation zone receiving the data segment containing MSB of the first piece of data;
a plurality of second operation zones, each second operation zone receiving a corresponding data segment, wherein the first operation zone and the second operation zones conduct a parallel crosstalk check on the data segments;
a plurality of first multiplexers, each first multiplex receiving an NOP segment from an NOP unit and the associated data segments to generate a shifted data segment; and
a plurality of second multiplexers, each second multiplex receiving a separation flag from a separation bits unit to incorporate into the corresponding shifted data segments;
wherein the separation flag and the shifted data segments form the second piece of data.

10. The bus architecture for crosstalk elimination of claim 9, wherein the first operation zone comprises:
a first data_register storing the data segment in the previous cycle; and
a first cross_detector checking crosstalk induced by the data segment on the first channel and the data segment on the first channel in the previous cycle to send a first select signal to a main selector.

11. The bus architecture for crosstalk elimination of claim 10, wherein each second operation zone comprises:
a data_register storing the data segment in the previous cycle; and
at least one cross_detector, each checking the crosstalk induced by the data segment stored in the data_register and sending a second select signal to the main selector.

12. The bus architecture for crosstalk elimination of claim 11, wherein the assembler comprises:
a deselector receiving the separation flag and generating a plurality of third select signals; and
a plurality of third multiplexers, each receiving the corresponding shifted data segments and the corresponding third select signal to restore the first piece of data.
